(19) United States
(12) Patent Application Publication
(10) Pub. No.: US 2009/0060464 A1
(43) Pub. Date: Mar. 5, 2009

(54) HANDHELD VIDEO PLAYBACK DEVICE

(76) Inventors: James Russell Hornsby, St. Louis, MO (US); Joseph Lee McGowan, St. Charles, MO (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/201,786

(22) Filed: Aug. 29, 2008

Related U.S. Application Data
(60) Provisional application No. 60/969,248, filed on Aug. 31, 2007.

(51) Int. Cl. H04N 5/00

(52) U.S. Cl. 386/117

(57) ABSTRACT

A portable, handheld video playback device for blending personal photographs into a variety of types of video content, and a method of making and using such as device. Generally, a user may be able to capture a facial image using an on-board image capture device. Using an interface of the video playback device, the user may insert the facial images into a variety of types of video content. Each piece of video content may be accompanied by an audible element. A video playback device may include a camera for capturing images, video content, memory for storing the captured images and video content, a processor for combining the captured images and video content, and a video screen for playing back the combined captured images and video content.

### RELATED APPLICATIONS

This application claims priority to U.S. Provisional Patent Application No. 60/969,248 filed Aug. 31, 2007, which is hereby incorporated by reference in its entirety.

### FIELD OF THE INVENTION

The present disclosure relates to apparatus and methods for a handheld video playback device suitable for a number of uses, e.g., entertainment, education, conveying information, communication, etc. More particularly, the present disclosure relates to apparatus and methods for a portable, handheld video playback device for blending personal photographs into a variety of types of video content and/or interactive video content.

### BACKGROUND OF THE INVENTION

Current technologies for handheld video playback devices include only playback capabilities. That is, the ability to select and play a specified set of pre-recorded videos. Some handheld video playback devices provide some interactive capabilities, such as selecting from a variety of options that lead to the playback of a certain clip. For example, a handheld video playback device may comprise a digital pet, which the user may, from time to time, select an option to feed, pet, play with, etc. the digital pet. Selection of one of these options leads to the playback of a specific clip in response to the selection. However, there is no interaction with the pre-recorded video clips, such as altering/personalizing the video clips.

Other current video playback technologies provide a capability for blending personal photographs into video clips. However, such technologies are web-based only and do not provide portable solutions. These technologies, such as that provided by Office Max® at www.elfyourself.com, rely on software, running on a server computer, and an internet connection to reach the end user. That is, in order to interact with this sort of video playback, the user must have a compatible computer with an internet connection and enough processing power to execute the software. As such, the user is very limited in the locations that the user can use the playback technology.

Thus, there is a need in the art for apparatus and methods for a portable, handheld video playback device for blending personal photographs into a variety of video clips or personalized animations.

### BRIEF SUMMARY OF THE INVENTION

The present invention, in one embodiment, is a video playback device including a camera for capturing images, video content, memory for storing the captured images and video content, a processor for combining the captured images and video content, and a video screen for playing back the combined captured images and video content. The video playback device may further include a speaker for playing audio accompanying the video content.

In one embodiment, the present invention comprises a portable, handheld video playback device for blending personal photographs into varieties of video content and/or interactive video content, such as for example, video games, video clips, personalized animations, and the like, and a method of making and using such as device. Generally, a user may be able to capture a facial image using an on-board image capture device. Using an interface of the video playback device, the user may insert the facial images into a variety of types of stored video content. The video content may be accompanied by an audible element. A video playback device may include a camera for capturing images, video content, memory for storing the captured images and video content, a processor for combining the captured images and video content, and a video screen for playing back the combined captured images and video content.

Other embodiments may include additional or different features and/or operational functions such as light-up screens, color images, clock functions, personal data storage, ability to update data, external data transfer, communication between other devices, multiple input sensors, e.g. RF, IR, audio, thermal, etc. The configuration or shape of the case or housing may be varied as suitable, and it may incorporate other objects or features, such as a desktop, alarm clock, etc., and the present invention may be incorporated into other devices, e.g. robots, plush toys, etc.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 is a front view of a video playback device in accordance with one embodiment of the present disclosure.

FIG. 2 includes a front, back, and partial side view of a video playback device in accordance with another embodiment of the present disclosure.

FIG. 3 is a block component diagram of a portion of a video playback device in accordance with a further embodiment of the present disclosure.

FIG. 4 is a diagram of a video playback device linked to an electronic device in accordance with another embodiment of the present disclosure.

FIG. 5 is a front view of a video playback device displaying a main menu screen in accordance with one embodiment of the present disclosure.

FIG. 6 is a flow diagram of interfacing with a main menu and camera screen in accordance with another embodiment of the present disclosure.

FIG. 7 is a flow diagram of interfacing with a video selection screen in accordance with an embodiment of the present disclosure.

FIG. 8 includes multiple embodiments of video clips in accordance with one embodiment of the present disclosure.

FIG. 9 includes multiple screenshots of an animation in accordance with a further embodiment of the present disclosure.

### DETAILED DESCRIPTION

The present invention is a novel and advantageous apparatus and method for a handheld video playback device. More particularly, the present disclosure relates to apparatus and methods for a portable, handheld video playback device for blending personal photographs into a variety of types of video content, such as for example, video games, video clips, or personalized animations. For purposes of the present disclosure, video content may include both non-interactive and interactive video content. Generally, a user may be able to capture a facial image using an on-board camera. Using an interface of the video playback device, the user may insert the facial images into a variety of types of video content. Each clip may be accompanied by an audible element. The video playback device may be relatively small, such that it may be handheld by the user. The handheld video playback device of the present disclosure may be used, for example, by children, teenagers, and adults in any environment, such as outdoors, at a mall, in a vehicle, etc. For example, a child may take the video playback device to school or to a playground, take a picture of a friend using the playback device, incorporate the resulting image into video content, and playback the video content with the image of the friend blended therein.

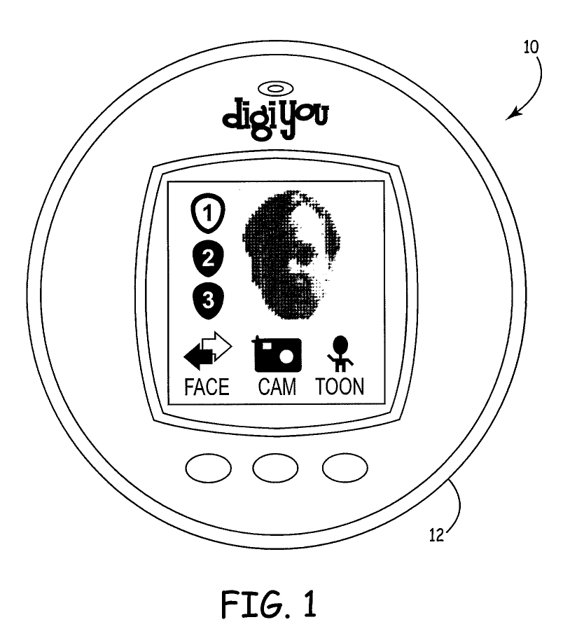

A video playback device 10 of the present disclosure may comprise a housing 12, as seen in FIG. 1. The housing may be generally round or shaped similar to a hockey puck. However, any housing geometry may be used, such as square, rectangular, or any polygon shape. The housing 12 may be one or more of a variety of colors. The housing 12 may be sized and/or adapted, such that the housing 12 is capable of being held easily in one hand. In a further embodiment, the housing 12 may be sized and/or adapted, such that the housing 10 is capable of being held easily in one hand of a child. In other embodiments, the housing 12 may be ergonomically shaped for a human hand.

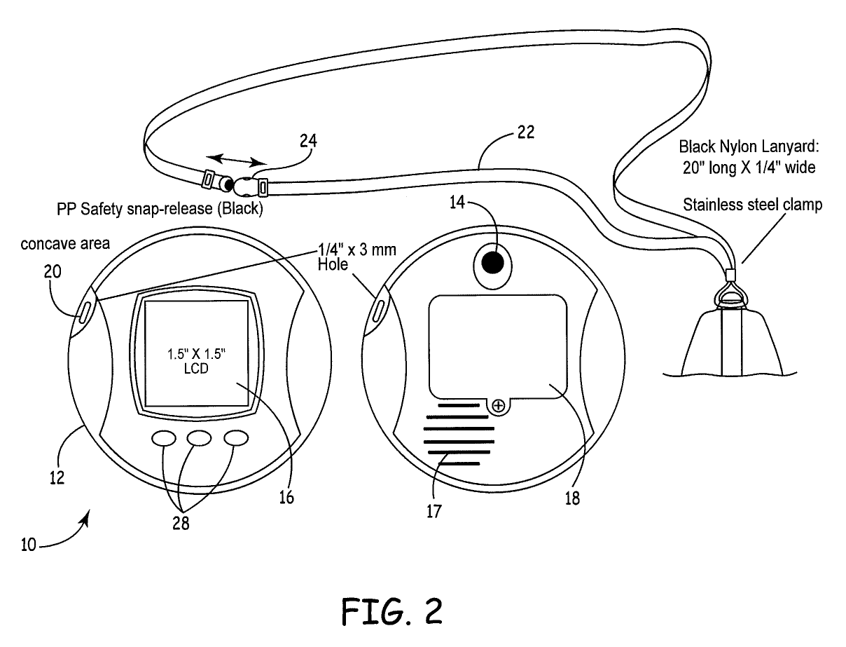

The video playback device 10 may include a camera and camera lens 14, as seen in FIG. 2. In one embodiment, the camera may comprise a CMOS image sensor. The camera may be used to capture images using the video playback device 10, as described in further detail below. In one embodiment, the camera may be used to capture facial images. However, the camera may be used to capture any image that the user desires to capture, e.g., of pets, scenery, objects etc.

The video playback device 10 may further include a video screen 16 for displaying menus, captured images, and/or video content. In one embodiment, the video screen 16 may be a low power, grayscale LCD screen. However, it is recognized that the video screen 16 may be any type of video screen and may be grayscale, black & white, color, etc. A low power, grayscale LCD screen may provide longer battery life than other video screen options. The video screen 16 may be any suitable size. In one embodiment, the video screen 16 may be about 60×64 pixels.

The video playback device 10 may include a speaker 17 for outputting audio. The video playback device 10 may provide audio clips that relate to the video content that is played on the playback device 10. As can be seen in FIG. 2, the video playback device 10 may also include a compartment 18 for receiving an energy source. In one embodiment, the energy source may be replaceable or rechargeable. In a further embodiment, the energy source may be one or more AAA batteries. In an even further embodiment, the energy source may comprise 3 AAA replaceable batteries. However, it is recognized that any number of suitably sized batteries (e.g., AA, C, etc.) may be used with the video playback device 10 described herein.

The housing 12 may include a notch, hole, or other connection or attachment means 20 for connecting a strap or lanyard 22 to the video playback device 10. The lanyard 22 may be used to carry the video playback device 10 or to attach the video playback device 22 to another object, such as a backpack, jacket or other article of clothing, etc. The lanyard 22 may include a connecting mechanism 24, such as a snap, buckle, carabiner, keychain, wrist band, hook and loop fabric, etc., so that the lanyard 22 may be separated and reattached.

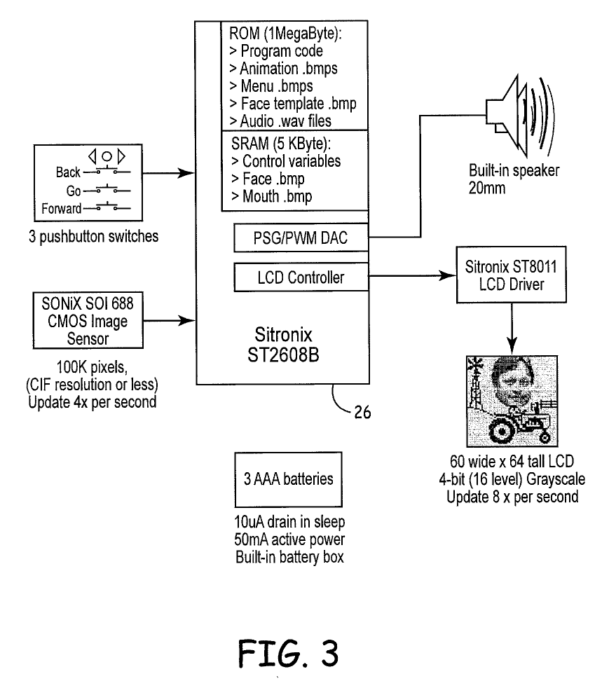

Unless specifically disclosed or taught, the video playback device 10 may include any suitable electronic devices and coupling or linking methods and apparatus. For example, the video playback device 10 may incorporate appropriate microprocessors, integrated circuits, chips, memory structures, wireless links, etc. Particularly, as illustrated in FIG. 3, the video playback device 10 may include a main controller IC 26 having RAM and ROM. In one embodiment, the RAM may be about 5 Kbytes and may be used for bitmap storage for control variables and captured images, such as the captured facial images. The ROM may be about 1 Megabyte and may be used for program and audio files and background images (e.g., bitmaps). However, it is recognized that the RAM and ROM may be larger or smaller in size and may be used for other storage and functions than those detailed above.

In one embodiment, the video content playback device 10 may include all of the electronic or computer hardware and software necessary for interactive video content, such as for example, a video game, to be operated on the video playback device 10.

The video playback device 10 may further include an interface for the user to communicate with the playback device 10 and/or interact with the video content. In one embodiment, one or more push buttons 28 may be provided on the housing 12. In a further embodiment, three push buttons 28 may be provided, each relating to different menu options presented to the user, as will be discussed in further detail below. Additionally, push buttons 28 may relate to different interactive options presented to the user. In other embodiments, the user may interact with the playback device 10 using other means, such as a touch screen.

In some embodiments, the video playback device may include a port, such as a USB port, so that the video playback device 10 may be linked to a second video playback device 100, such as a computer, or other suitable electronic device. The link may be used to transfer, download, upload, interact, etc. between the linked devices. Such a link may be used, for example, to transfer animations or captured images between the devices, download additional or different animations to one of the devices, upload animations or captured images to one of the devices, etc.

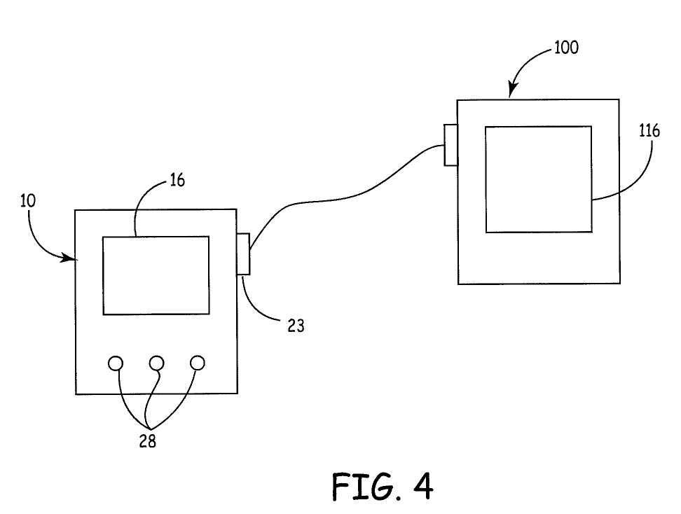

Referring to FIG. 4, in further embodiments, the video playback device may also include a communication port 23, such as a component video port, USB port, or any other suitable communication port including those configured for wireless communication, so that the video playback device 10 may be linked to a second electronic device 100, such as for example, a television, a computer, and/or a gaming system. The link may be used for displaying menus, captured images, and/or video content on a video screen 116 of the second electronic device 100 in lieu of or in addition to the video screen 16. The output sent to the video screen 116 via the link may the same output or a different output than that sent to the video screen 16. In a further embodiment, the video playback device 10 may be provided without a video screen and the video screen 116 of the second electronic device may be the only means for displaying menus, captured images, and/or video content.

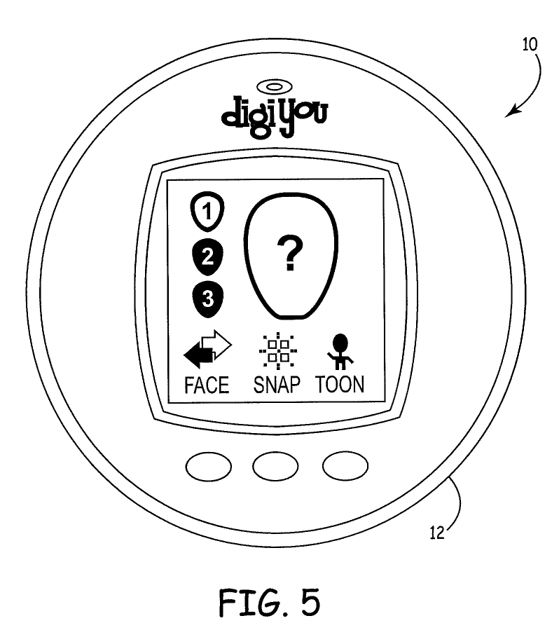

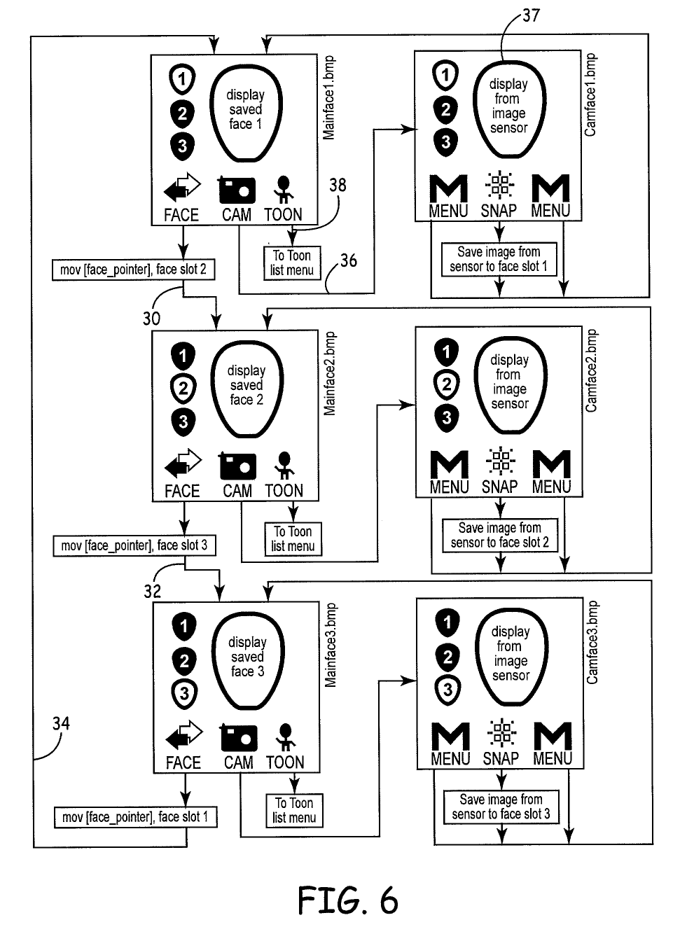

When turned on, a user may be presented with a main menu, as shown in FIGS. 5 and 6. From the main menu, the user may, using the push buttons 28, navigate through the different functions of the video playback device 10.

In one embodiment, using the corresponding push button 28, a user may select from one or more captured image slots. In a further embodiment, a user may select from three captured image slots, as illustrated in the Figures on the video screen 16 by reference numerals “1,” “2,” and “3.” However, it is recognized that any suitable number of captured image slots may be available for the user to select from, generally depending on the amount of memory available in the video playback device 10. The user may switch between captured image slots by pressing the corresponding push button 28 (flowchart lines 30, 32, and 34). Actions taken with respect to each of the available captured image slots are the same. Thus, the description herein references actions that may be taken with respect to captured image slot “1,” and it is recognized that such actions may be applicable to the other captured image slots.

If a captured image slot (e.g., captured image slot “1”) does not contain an image or if the user desires to replace a current captured image with a new image, the user may capture an image using the camera by pointing/aiming the camera lens 14 toward the object the user desires to capture. In one embodiment, the user may capture any image of a person's or animal's head/face. However, the user may capture any image they desire.

In one embodiment, the user may press the corresponding push button 28 for activating the camera (flow chart line 36). The video screen 16 may present the user with a picture window area 37 for aligning with the object the user desires to capture as a picture. In one embodiment, the picture window 37 may be in the shape of a human head or face. The user may line up the object, as seen through the camera lens 14, within the picture window area 37. The user may then push the corresponding push button 28 for taking a picture of the object. In one embodiment, any portion of the object (or objects) that is not within the picture window area 37 may be cut from the saved captured image. The image captured by the camera may then be stored in the corresponding captured image slot (e.g., captured image slot “1”). From the camera screen, the user may return back to the main menu by selecting an appropriate push button 28 or may be automatically returned to the main menu by the video playback device 10, such as after an image has been captured by the camera and saved in memory.

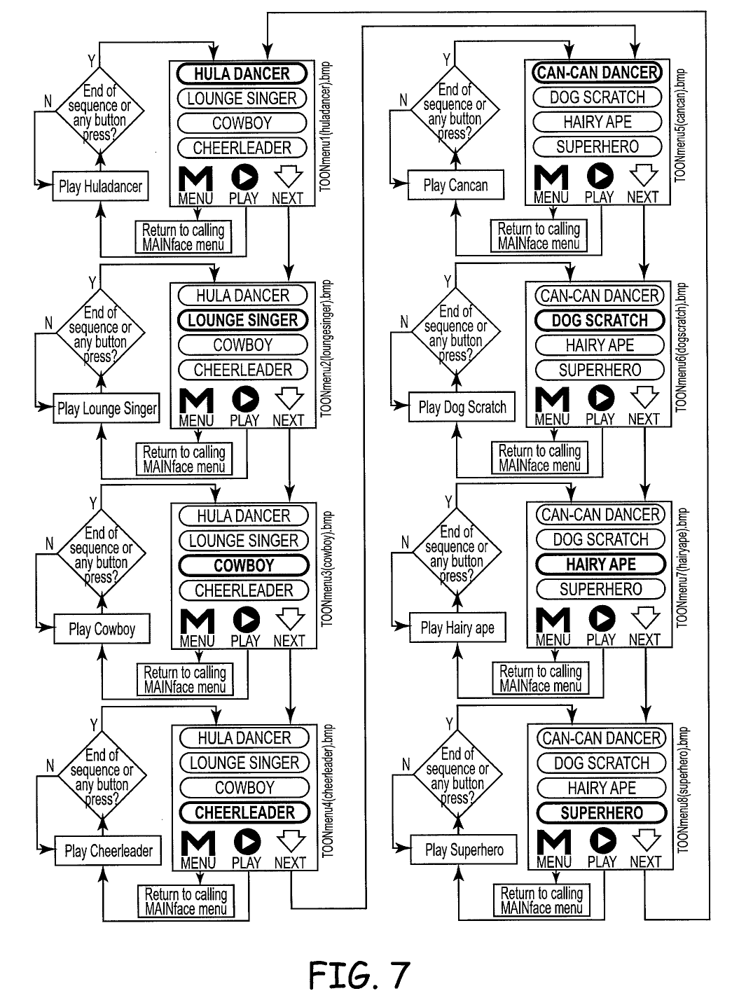

From the main menu, the user may select to have the captured image (e.g., captured image “1”) incorporated/placed into video content by pressing the corresponding push button 28 (flowchart line 38). As illustrated in FIG. 7, the user may be presented with a variety of menu selections, each corresponding to a different video content that the captured image may be combined with. From this menu, the user may choose to return to the main menu, play the highlighted video content with the captured image, or view more available video content by selecting the corresponding push button 28. A variety of types of video content may be pre-stored/pre-recorded and provided with the video playback device 10. In other embodiments, the video content may be downloaded from another source, such as another video playback device 10, a personal computer (including a personal computer with an internet connection), etc. by linking the video playback device 10 with the other source. In some embodiments, the link may be physical, such as a USB cable. In other embodiments, the link may be wireless.

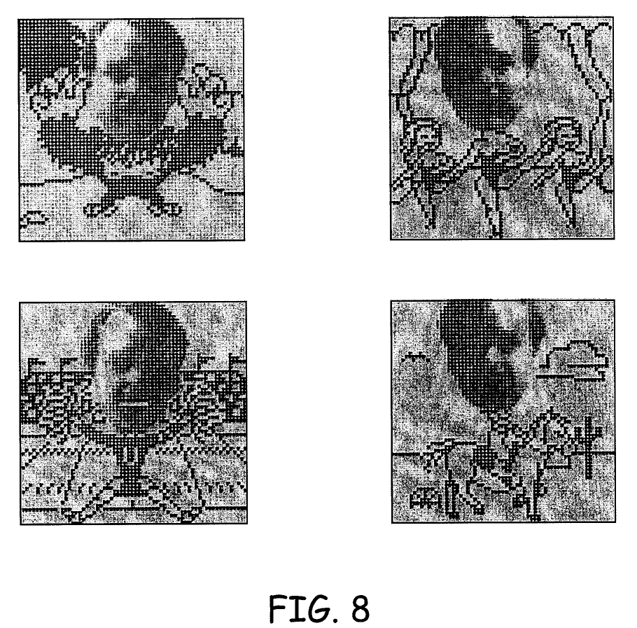

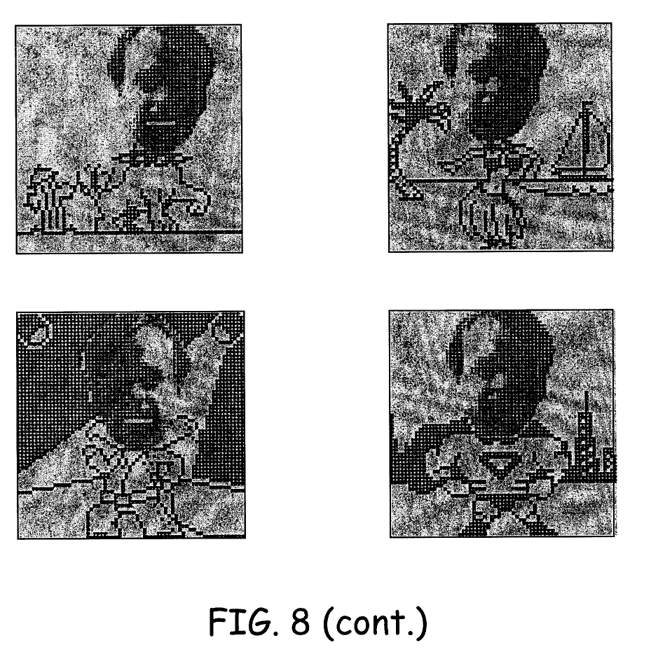

In one embodiment, the video content may include animations and/or video clips. The animations and/or video clips may be generic animations and/or video clips (which may include copyrighted or trademarked subject matter), such as, for example and not limited to, animations comprising an ape, a can-can dancer, a cheerleader, a cowboy, a dog, a hula dancer, a lounge singer, or a superhero, as illustrated in FIG. 8. It is recognized that any variety of animations and/or video clips may be used with the video playback device 10 described herein, and any number of animations and/or video clips may be provided with the video playback device 10 or downloaded from another source, generally depending on the amount of memory available.

In some embodiments, the video content may include interactive video content, such as for example, video games. Video games may include any software-based content that involves interaction with a user interface to generate visual feedback on the video playback device 10 and/or electronic device linked thereto. It is recognized that any variety of video game may be used with the video playback device 10 described herein, and any number of video games may be provided with the video playback device 10 or downloaded from another source, generally depending on the amount of memory available. In one embodiment, the interactive video content may include a “makeover” video game. The video game may be configured such that a user may put an image, such as an image of themselves or a friend, on the video screen 16 and perform interactive activities on the video playback device 10, which change the appearance of the image.

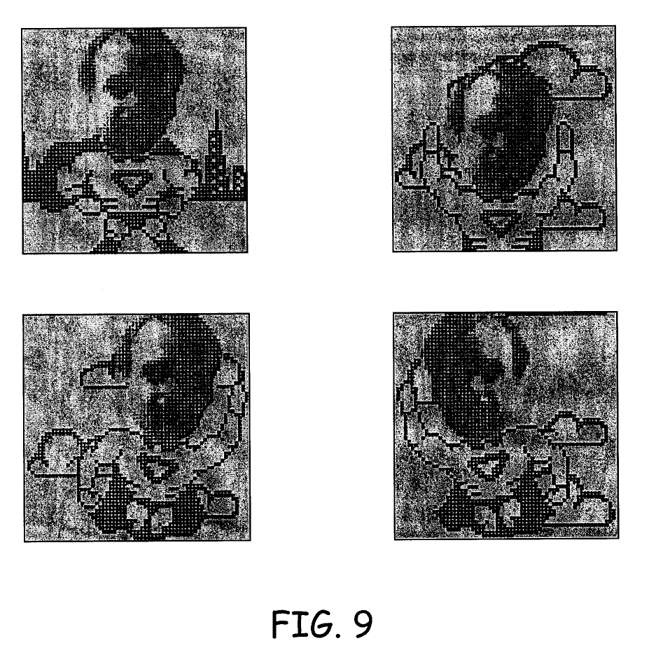

As can be seen in FIG. 9, exemplarily illustrating portions of a superhero animation, the video content may provide motion and animation including the captured image. In the exemplary video content illustrated in FIG. 9, the captured image is a facial image, and the facial image is placed onto an animated superhero's body. However, it is recognized that the captured image may be used in any video content in any manner and is not limited to use of facial images on animated bodies.

In a further embodiment, the video content may include subject matter or characters that are proprietary to third parties. For example, the video content may include Disney® characters or other animated franchised characters. In another example, the video content may include characters from books, television, or movies, such as Spiderman®, Transformers®, Spongebob Square Pants®, etc. In further embodiments, the video playback device, as a whole, may be themed to a specific subject matter or character and may include video content relating to that particular subject matter.

In further embodiments yet, audio may be provided for the video content. Each piece of video content may have different audio components provided therewith. In a further embodiment, the audio may include subject matter, songs, voices, etc. that are proprietary to third parties. For example, the audio may include Disney® songs, voices, etc. or other animated franchised songs, voices, etc. In another example, the audio may include audio from books, television, or movies, such as Spiderman®, Transformers®, Spongebob Square Pants®, etc.

Although the present invention has been described with reference to preferred embodiments, persons skilled in the art will recognize that changes may be made in form and detail without departing from the spirit and scope of the invention.

We claim:

1. An apparatus for video playback, comprising:
a camera for capturing one or more images;
a plurality of video and image content;
memory for storing the captured images and video and image content;
a processor and logic used thereby for combining one or more of the captured images and at least a portion of the video and image content, such that the one or more captured images and the at least a portion of video and image content form a single stream of video content or a single image having the features of both the one or more captured images and the at least a portion of video and image content; and
a display screen for displaying the captured images and for playback of the combined single stream of video content or a single image having the features of both the one or more captured images and the at least a portion of video and image content.

2. The apparatus of claim 1, further comprising a speaker for playing audio accompanying the video content.

3. The apparatus of claim 1, further comprising a user interface for interacting with the camera and for selecting the one or more captured images and the at least a portion of video and image content to be combined.

4. The apparatus of claim 1, wherein the video content comprises video games, video clips, and/or personalized animations.

5. The apparatus of claim 1, wherein the video content comprises a video game configured to allow a user to alter the appearance of a captured image.

6. The apparatus of claim 1, wherein the display screen comprises a low power, gray scale LCD screen.

7. The apparatus of claim 1, further comprising a compartment for receiving an energy source, wherein the energy source comprises batteries.

8. The apparatus of claim 1, wherein when the camera is activated, the display screen presents a user with a picture window area for aligning with an object.

9. The apparatus of claim 8, wherein the picture window area is sized and shaped for a human or animal face.

10. The apparatus of claim 8, wherein only the object(s) within the picture window area presented to the user on the display screen are stored in the memory.

11. The apparatus of claim 3, wherein the user interface comprises one or more push buttons each relating to different menu options presented to the user.

12. The apparatus of claim 3, wherein the user interface comprises one or more push buttons each relating to different interactive options available to the user.

13. The apparatus of claim 1, further comprising a linking port configured such that the apparatus may be linked to a second electronic device for outputting the combined single stream of video content or a single image having the features of both the one or more captured images and the at least a portion of video and image content.

14. The apparatus of claim 13, wherein the output is sent to the second electronic device in lieu of or in addition an output being sent to the display screen.

15. The apparatus of claim 13, wherein the output sent to the second electronic device is different than an output sent to the display screen.

16. A method for displaying interactive video content comprising:
providing a device having a first memory location, a second memory location, a processor, and a camera for capturing images;
storing captured images in the first memory location;
receiving input from a user identifying one of a plurality of interactive video content options stored in the second memory location;
receiving input from a user identifying a captured image; and
displaying the combined captured image and interactive video content.

17. The method of claim 16, wherein the device further comprises a video screen, and wherein the combined captured image and interactive video content is displayed on the video screen.

18. The method of claim 16, wherein the device further comprises a linking port configured such that the device may be linked to a second electronic device, and wherein the combined captured image and interactive video content is displayed on the second electronic device.

19. An apparatus for video playback, comprising:
a camera for capturing images;
video content;
memory for storing the captured images and video content;
a processor for combining the captured images and video content; and
means for playing back the combined captured images and video content.
